(19) United States
(12) Patent Application Publication
(10) Pub. No.: US 2015/0190719 A1
(43) Pub. Date: Jul. 9, 2015

(54) Systems and Methods of Crowd Sourced Virtual Character Evolution

(71) Applicant: 2343127 Ontario Inc., Toronto (CA)

(72) Inventors: Yousuf Chowdhary, Maple (CA); Jeffrey Brunet, Aurora (CA); Ravinder ("Ray") Sharma, Toronto (CA)

(21) Appl. No.: 14/151,342

(22) Filed: Jan. 9, 2014

(51) Int. Cl. A63F 13/67

(52) U.S. Cl. CPC A63F 13/67

(57) ABSTRACT

A computer-implemented method is provided for providing virtual gameplay. Access is provided to a video game in which players are able to interact via characters and each character behaves according to a series of scripts in a script set. A first player character is monitored as it interacts with a second character in the video game. The second character responds according to a script in its script set. When the first player character exhibits repetitive behaviour in the interaction that causes damage to the second character that exceeds a preset damage threshold, the second character's script is changed and the changed script is stored for future use. As strings are changed over successive iterations, the second character evolves.

### FIELD OF INVENTION

The present invention is related to video game applications in general and video game applications where virtual characters evolve as they interact with a large number of players in particular.

### BACKGROUND

When fighting and defeating a villain or monster requires a set number of techniques or attacks, a player may lose interest in the game. Predictability in how a virtual character behaves and how it is defeated also encourages a sort of cheating whereby a player can go online (e.g. to YouTube) and see how other players have defeated the villain, and then the player can repeat the same techniques in the game to defeat the said villain.

Additionally, when repetitive and mindless activities like farming and mining are needed, players may get bored or may have other players perform that activity for them. Similarly, when defeating a boss/monster/enemy is repetitive it takes away from the fun of playing the game and the players do not get the same sense of achievement as when defeating a unique and difficult to beat enemy. For example, in certain existing games, an attack move by a player may inflict 10 damage points to the villain. If the villain has 100 health/life points, then 10 such moves by the player can effectively defeat the villain. This makes the game predictable, repetitive and boring while taking away from the challenge.

A virtual world is a computer simulated environment. A virtual world may resemble the real world, with real world rules such as physical rules of gravity, geography, topography, and locomotion. A virtual world may also incorporate rules for social and economic interactions between virtual characters. Players (users) may be represented as avatars, two or three-dimensional graphical representations. Virtual worlds may be used for massively multiple online role-playing games, for social or business networking, or for participation in imaginary social universes.

Prior art virtual worlds present a static experience when engaging in gameplay. By overcoming these limitations, the present invention allows for a richer and more unique gameplay experience for each player.

### SUMMARY OF THE INVENTION

It would be desirable to have a gameplay whereby the virtual characters evolve based on their interaction with different players, allowing virtual characters to learn from their recent defeats and vary their techniques so that the next player who happens to have an encounter with the virtual character cannot defeat it using the same technique that was used last time to defeat it.

In one embodiment of the invention, the game may start with a “string-set” that may contain more than one string to emulate different behaviors for the same virtual character. For example different strings like Easy, Medium and Hard for a monster (villain, boss, enemy, arch-nemesis etc.) may compose the string set at the beginning. Thus the monster may variably exhibit different levels of challenge required to defeat it using a different string. As more players interact and try to defeat the monster, it learns from the techniques of the players and mid-session may combine components from different strings in its string set. For example components from the Easy string may be combined with the components of a hard string. Thus the resultant behavior of the monster is different since now it has the combined characteristics of two different strings. This new string is now also added to the earlier string set. Thus next time when combining characteristics this new string may also be used along with the previous strings in the string set. Thus as more time goes by, there are more strings to choose from when an alternate behavior for the virtual character (monster, boss, villain, hero etc.) is required. This ensures that no two players when interacting with the same virtual character (villain or other) will have the exact same experience, therefore essentially requiring different techniques to defeat the same virtual character. This will also be true when the same player encounters the virtual character on two different occasions, either in the same level or on different levels of the game.

This application describes systems and methods whereby the virtual characters in a virtual world may change based on the interactions with real world players. Thus the more players interact with the virtual character, the more sophisticated it becomes as it learns and morphs with each interaction. This provides for a richer gaming experience and increases player engagement while making the gameplay of the virtual world more unique for each player. The systems and methods described here enable a player to have a unique and more enjoyable gaming experience.

According to a first aspect of the invention, a computer-implemented method is provided for providing virtual gameplay on a computing device in communication with a storage means. Access is provided to a video game in which players are able to interact via characters and each character behaves according to a series of scripts in a script set. A first player character is monitored as it interacts with a second character in the video game and the second character responds according to a script in its script set. Upon the first player character exhibiting repetitive behaviour in the interaction that causes damage to the second character that exceeds a preset damage threshold, the second character's script is changed. The changed script is stored on the storage means for future use.

Both the first player character and the second character can be player characters or non-player characters. In a preferred embodiment, the first player character is a player character and the second character is a non-player character (i.e. not under the direct control of a human player). However, it will be appreciated that even player characters can behave (at least in part) according to scripts, and the method can also be appropriate (with modifications as needed) where the second character is a player character.

In one embodiment, changing the script includes replacing the script with another script from the script set. For example, the replacement script may be replaced by a script for a higher level than would otherwise be default.

In one embodiment, each script has at least two sub-components. In this case, changing the script may include combining or replacing at least one of the sub-components with sub-components from another script in the script set. Preferably, each sub-component includes at least one statistic. The statistic may be a primary statistic or a derived statistic. Changing the script can also include changing the formula or algorithm by which a derived statistic in the sub-component is derived.

In another embodiment, changing the script includes combining or replacing the script with a script that has been downloaded, transferred, purchased, gifted, won, or lost, or restored or linked from another game. Any of the foregoing steps can be initiated by the player/user or the system (as appropriate according to the method, or as triggered by a behavior(s) of the player/user).

After the script is changed, the first player character is preferably allowed to continue the interaction with the second character with the changed script invoked. In this case, the second character will behave according to the changed script. For example, the second character may be detectably strengthened by invocation of the changed script. Or, for example, the second character may be detectably faster by invocation of the changed script. In another embodiment, invoking the script may result in the second character having at least one non-default move, attack or defence, and/or at least one non-default tool or weapon (including, armour, property, gold, etc.). In another embodiment, the second character may have detectably increased health or life by invocation of the changed script.

Various configurations of storage are possible. Preferably, the storage means is provided by one or a combination of: a local fixed memory, a local removable memory, a remote fixed memory, a remote removable memory, and a virtual memory.

### BRIEF DESCRIPTION OF THE FIGURES

FIG. 1 is a flow diagram illustrating the primary steps of the method, according to a preferred embodiment.

FIG. 2 is a flow diagram illustrating an ongoing process for evaluating repetitive and damaging moves to trigger evolving a virtual character by changing strings.

FIG. 3 is an illustrative notional data structure showing statistics of a virtual character and possible combinations of statistics to evolve the virtual character.

FIG. 4 is an illustrative notional data structure showing statistics of a virtual character and possible combinations of statistics to evolve the virtual character.

FIG. 5 is an illustrative notional data structure showing statistics of a virtual character and possible combinations of statistics to evolve the virtual character.

FIG. 6 is an illustrative notional data structure showing statistics of a virtual character and possible combinations of statistics to evolve the virtual character.

FIG. 7 is a conceptual diagram illustrating evolution of default strings into multiple combinations and sub-combinations over time.

FIGS. 8A-8B are conceptual diagrams illustrating an interaction between two virtual characters before and after a change of the second character's script.

### DETAILED DESCRIPTION

Methods and arrangements of evolving virtual characters for gaming applications and virtual worlds are disclosed in this application.

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A “virtual world” as used herein need not be a “game” in the traditional sense of a competition in which a winner and/or loser is determined, but rather that the term “game” incorporates the idea of a virtual world. Moreover, a person or entity that enters the virtual world in order to conduct business, tour the virtual world, or simply interact with others or the virtual environment, with or without competing against another person or entity is still considered to be “playing a game” or engaging in the gameplay of the game.

Virtual worlds can exist on game consoles for example Microsoft Xbox, and Sony Playstation, Nintendo Wii, etc., or on online servers, or on mobile devices (e.g. an iPhone or an iPad), Smartphones, portable game consoles like the Nintendo 3DS, or on a PC (personal computer) running MS Windows, or MacOS, Linux or another operating system. This list is not exhaustive but is exemplary of devices or computing environments where virtual worlds can exist, many other variations are available and known to persons skilled in the art.

A computer or a game console that enables a user to engage with a virtual world, including a memory for storing a control program and data, and a processor (CPU) for executing the control program and for managing the data, which includes user data resident in the memory including a set of gameplay statistics. The computer, or a game console, may be coupled to a video display such as a television, monitor, or other type of visual display while other devices may have it incorporated in them (iPad). A game or other simulations may be stored on a storage media such as a DVD, a CD, flash memory, USB memory or other type of memory media. The storage media can be inserted to the console where it is read. The console can then read program instructions stored on the storage media and present a game interface to the user.

Typically, a user or a player manipulates a game controller to generate commands to control and interact with the virtual world. The game controller may include conventional controls, for example, control input devices such as joysticks, buttons and the like. Using the controller a user can interact with the game, such as by using buttons, joysticks, and movements of the controller and the like. This interaction or command may be detected and captured in the game console. The user's inputs can be saved, along with the game data to record the game play. In one embodiment, the gameplay data can include usage statistics captured to record the user's experience as they progress from one level of the game to the next.

The term “player” is intended to describe any entity that accesses the virtual world, regardless of whether or not the player intends to or is capable of competing against other players. Typically, a player will register an account with the game console within a peer-to-peer game and may choose from a list or create virtual characters that can interact with other virtual characters of the virtual world.

The term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity.

A “virtual character” may include a persona created by a player or chosen from a list in the virtual world. Typically virtual characters are modeled after the humans whether living or fantasy (e.g. characters from mythology). In this disclosure the term virtual character is used interchangeably with villain, boss, monster etc. but the intent is to mean any kind of a virtual character whether it is a protagonist or an antagonist, celebrity, champion, conqueror, charlatan, daredevil, entrepreneur, explorer, fortune-hunter, gambler, globetrotter, hero, heroine, hobbit, madcap, mercenary, magician, mage, opportunist, pioneer, pirate, romantic, speculator, stunt person, swashbuckler, traveler, voyager, wanderer or the like.

A virtual character is represented by one or more gameplay statistics, which encapsulate some meaning to connect the virtual (and digital) reality of the game to the real world. Many of these statistics are not apparent to the user as such, but are instead encoded within the framework of the game or composed together to form a script. In role-playing games (RPGs) and similar games, these statistics may be explicitly exposed to the user through a special interface, often with added meaning which provides context for the user's actions.

In virtual worlds (video/computer games) a non-player character (NPC) is a virtual character that is controlled by the program and not a player. NPC may also refer to other entities not under the direct control of players. NPC behavior in a virtual world may be scripted and automatic.

A “player character” or “playable character” (PC) is a virtual character in a virtual world that is controlled or controllable by a player. A player character is a persona of the player who controls it. In some cases a virtual world has only one player character and in other cases there may be a small number of player characters from which a player may pick a certain virtual character that may suit his or her style of gameplay, while in other scenarios there may be a large number of customizable player characters available from which a player may choose a virtual character of their liking. An avatar—may include the physical embodiment of a virtual character in the virtual world.

The system and method described in the patent disclosure is equally applicable to any type of a virtual character whether it is protagonist or an antagonist, PC or NPC, male or female, or any other kind that is obvious to the one skilled in the art.

Statistics (Stat)

A “statistic” (stat) in role-playing games (RPG) is a datum which represents a particular aspect of a virtual character. Most virtual worlds separate statistics into several categories. The set of categories actually used in a game system, as well as the precise statistics within each category may vary greatly from one virtual world to another. Many virtual worlds also use derived statistics whose values depend on other statistics, which are known as primary or basic statistics. Derived statistics often represent a single capability of the character such as the weight a character can lift, or the speed at which they can move. Derived statistics are often used during combat, can be unitless numbers, or may use real-world units of measurement such as kilograms or meters per second.

Primary Statistics represent assigned, abstract qualities of a virtual character, such as Strength, Intelligence, and so on. Partially defined by convention and partially defined by context, the value of a primary statistic corresponds to a few direct in-game advantages or disadvantages, although a higher statistic is usually better. In this sense, primary statistics can only really be used for direct comparison or when determining indirect advantages and disadvantages.

Derived Statistics represent measured, concrete qualities of a virtual character, such as maximum carry weight, perceptiveness, or skill with a weapon. Such a stat is derived from some function of one or more of a character's primary stats, usually addition or multiplication. These stats then serve an important function in turn, providing a fair means by which to arbitrate conflicts between virtual characters and the virtual environment. For example, when two virtual characters are in violent conflict, Strength, a primary statistic, might be used to calculate damage, a derived statistic, with the winner being the character with the most damage.

Other factors may affect derived statistics, such as other derived or primary statistics, or even environmental factors, such as weather conditions. In these cases, the environment can be modeled as a virtual character with its own primary statistics or it may be given a special role in conflict resolution. Whatever-the-case, the role of primary statistics should remain clear because this is the primary interface by which players understand their interactions within the virtual world.

Some statistics deserve special mention. “Health (or Hit Points) vs. Damage,” describes a gameplay mechanic that has fixated the current generation of games. Damage refers to a primary or (usually) derived statistic that represents a character's ability to destroy or cause harm to the environment or virtual characters. Likewise, Health (or Hit Points) refers to a primary or (usually) derived statistic that represents a character's ability to withstand damage and continue to function normally. Each time a character suffers damage, that amount of damage is subtracted from their remaining health or hit point total, and if this total is now zero or less, the character is eliminated or the player loses.

A virtual character's statistics affects how it behaves in a virtual world. For example, a well-built muscular virtual character may be more powerful and be able to throw certain virtual objects farther, but at the same time may lack dexterity when maneuvering intricate virtual objects. A virtual character may have any combination of statistics, but these statistics may be limited by either a hard counter, soft counter or a combination of both. The most often used types of statistic include but are not limited to the following:

Attribute/Ability
An “attribute/ability” describes to what extent a virtual character possesses a natural, in-born characteristic common to all virtual characters in the game. Ability defines a quality in a virtual character to perform certain actions, for example wield a sword or to run. Many games use attributes to describe a virtual characters' physical and mental characteristics, for example their strength or wisdom. Many games also include social characteristics as well, for example a character's natural charisma or physical appearance which often influence the chance to succeed in a particular challenge. Some games work with only a few broad attributes, while others may have several more specific ones.

Trait
“Traits” may be stable personal characteristics (i.e., temperament or physical endowment) that are additional qualities that help define a virtual character. Traits can be positive or negative. Traits also affect the ability to build particular skills. For instance, an active virtual character will find it easier to develop a more muscular body than an inactive one. Generally a trait represents a broad area of expertise of a character.

Skills
A “skill” represents the learned knowledge of a virtual character. Skills are manifestations of abilities and traits. During the creation of a virtual character, skills are generally chosen from a list. A virtual character may have a fixed number of starting skills, or a player can acquire them by spending game points. Each skill has an associated attribute and can be improved upon by practicing. For example if a virtual character has the ability to wield a sword and has the trait of being physically strong then the skill of being a swordsman can be accomplished by practicing wielding the sword. As opposed to abilities few games set a player's skills at the start of the game, instead allowing players to increase them by playing the game and spending game points or during moving from a low level to a higher level in the game. Some skills are likely to be more useful than others therefore different skills often have different costs in terms of game points.

Advantages and Disadvantages
An “advantage” is a physical, social, intellectual, or other enhancement to a virtual character, while a disadvantage is an adverse effect. Advantages are also known as virtues, merits or edges and disadvantages as flaws or hindrances. Many games encourage or even force players to take disadvantages for their characters in order to balance their advantages or other positive statistics.

Powers
“Powers” represent unique or special qualities of a virtual character and often grant the virtual character the potential to gain or develop certain advantages or to learn and use certain skills.

For the purpose of this application the term “gameplay statistics” refers to any one or any combination of gameplay frequency, gameplay time, number of times game played, percent game complete etc. as result of engaging in gameplay.

Encounters

In a virtual world an “encounter” may be defined as a meeting between two or more virtual characters or may be thought of as a decision point at which a player encounters an opposing element (e.g. an enemy). An encounter may be player initiated (actively engaging in fighting an enemy) or unwanted by the player. A player may opt to avoid an encounter or may actively engage in them to move to the next level of the virtual world. The outcome of the encounters may at times define how the rest of the game progresses.

A random encounter is a feature commonly used in various role-playing games (RPGs) whereby an encounter with a non-player character (NPC), an enemy, a monster, or a dangerous situation occurs sporadically and at random. Random encounters are generally used to simulate the challenges associated with being in a hazardous environment, such as a monster-infested wilderness or dungeon usually with an uncertain frequency of occurrence to simulate a chaotic nature.

Settings

“Settings” in the virtual world control multiple areas of the virtual world (game). Settings may be changed by a player or may be impacted by the location of a player.

Levels

A “level” in the virtual world (video game) terminology refers to a discrete subdivision of the virtual world. Typically a players begins at the lowest level (level 1), and proceeds through increasingly numbered levels, usually of increasing difficulty, until they reach the top level to finish the game. In some games levels may refer to specific areas of a larger virtual world, while in other games it may refer to interconnected levels, representing different locations within the virtual world.

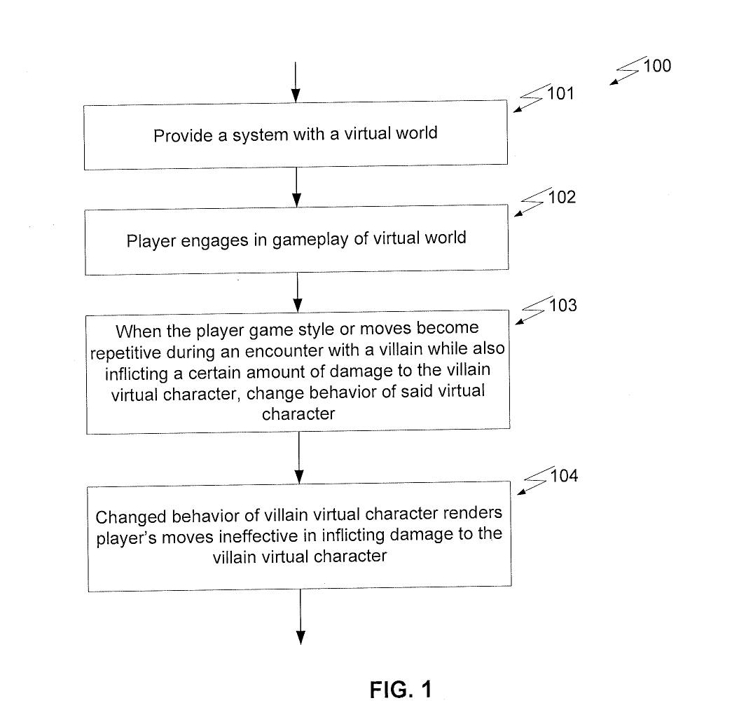

FIG. 1 is a flow diagram illustrating the primary steps of the method, according to a preferred embodiment. A system is provided with a virtual world 101. The virtual world may be a single player game or a multiplayer game or a MMORPG (Massively Multiplayer Online Role Playing Game) and may exist on any type of a gaming device which may include but not limited to an iPhone, iPad, Smartphones, Android phones, personal computers e.g. laptops, gaming consoles like Nintendo Wii, Nintendo DS, Sony PlayStation, Microsoft Xbox 360, and online server based games etc.

The computer program comprises: a computer usable medium having computer usable program code, the computer usable program code comprises: computer usable program code for enabling change in storyline based on the real world location of a player, computer usable program code for presenting graphically to the player the different options available to modify and personalize different aspects of the virtual world including but not limited to settings.

The player engages in gameplay of the virtual world 102. As mentioned earlier, the term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity.

When the player game style or moves become repetitive during an encounter with a villain while also inflicting a certain amount of damage to the villain virtual character, the system changes the behavior of the villain virtual character 103.

The behavior of said villain virtual character may be altered by changing the default script that is controlling the behavior of the virtual character. A script defines the default behavior of a virtual character. If there is no external stimulus a virtual character acts as per the default script. Just as with statistics, different scripts can refer to different behaviors for virtual characters.

The changed behavior of the villain virtual character renders the player's moves ineffective in inflicting damage to the villain virtual character 104.

In one embodiment of the invention, another string that is already present in the string set can be used to alter the behavior of the villain virtual character, forcing the player to seek other moves in continuing to defeat the said villain character. Once all strings in the string set have been used to alter the behavior of the villain virtual character, stats can be combined from different strings in the string set associated with the virtual character to form a new string to change the behavior of said villain virtual character.

In another embodiment, new strings can be obtained by combining stats from more than one script (or strings) associated with the said villain virtual character.

In another embodiment, any virtual character may follow this path of changing behavior, and it is not just limited to the villain, boss, or monster.

In one embodiment, when a first player engages in gameplay with the virtual character of a virtual world, this interaction may alter the existing default scripts by combining elements from more than one string that may be already present in the virtual world.

Even with a default script of a single virtual character, many behaviors are possible. In fact, the manner by which derived statistics are calculated can itself be defined by a particular script, rather than a simple function. For this reason, it is sometimes difficult to determine whether a derived statistic refers more to a particular measurable quality or the behavior that defines that quality. For example, a skill may be represented by a statistic where a higher value corresponds to a higher degree of skill in some particular endeavor. However, a trait may refer to the behavior that defines that trait, rather than simply a statistic. In this way, it is important to distinguish when skills, traits, abilities, and other game components are represented by statistics or behaviors.

Once altered, the new string (which is a combination of two or more earlier strings) can be saved in the preferred memory location. Most devices where virtual worlds exist provide a mechanism to save the state of the game, so that the game can be played from the same point where it was left off. Methods for saving the state of the game include but are not limited to the examples cited here, for example a gaming console may provide internal memory chips, or a port where a user can connect user supplied memory; while games played over the Internet may provide online memory. The aforementioned memory space can also be used for saving the different components of the storyline that are affected by the change in the real world location of the player to enhance the gameplay experience.

The memory location may be the local data storage (internal memory) of a game console including one for the linked linkable and extensible virtual character. The local data storage can be local inbuilt memory (for example on board memory) or user provided (for example a USB device, a Flash Memory SD card etc.) such that said memory is accessible to other virtual worlds. In another embodiment the memory location may be an online server

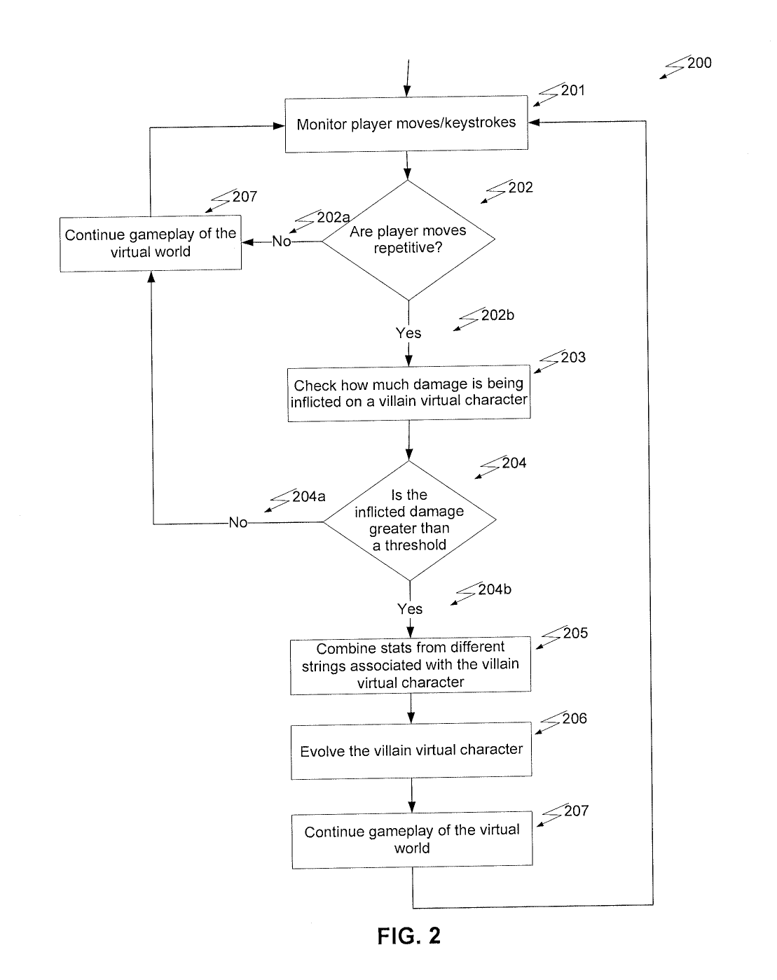

FIG. 2 is a flow diagram illustrating an ongoing process for evaluating repetitive and damaging moves to trigger evolving a virtual character by changing strings. Gameplay starts using a default script for the virtual character and monitor player moves/keystrokes 201. The player may use any one of the several possible mechanisms to interact with the virtual world including but not limited to a gamepad, keyboard, mouse, joystick, wired game controller, wireless remote game controller or other such mechanism. To monitor player moves and keystrokes implies taking into consideration the moves that a player is making and checking for a pattern.

The system checks to see if the player's moves/keystrokes are repetitive 202. If No 202a (i.e. the player's moves/keystrokes are not repetitive) then gameplay of the virtual world continues 207 and the system continues to monitor player moves/keystrokes periodically 201. Any key combinations or button combinations that are used more frequently than other combinations, or being used repetitively for example pressing the “fire” button repeatedly to fire indiscriminately would fall in this category.

If there are no repeated patterns in the player moves in a given time period then it can be concluded that the player moves are non-repetitive.

If Yes 202b (i.e. there are repeated patterns in the moves that a player is making in a given period of time), then it can be concluded that the player moves are repetitive. For example pressing the “fire” button repeatedly with no other significant moves made over a given period of time e.g. 60 seconds concludes that the player is using a repeated move.

The system (concurrently or in sequence) checks how much damage is being inflicted on a villain virtual character due to the repetitive moves of a player 203.

Health is a game mechanic used in virtual worlds to give a value to virtual characters, enemies, NPCs, (non player characters) and related virtual objects. Health is often abbreviated by HP which may stand for health points or hit points; it is also synonymous with damage points or heart points. In virtual worlds health is a finite value that can either be numerical, semi-numerical as in hit/health points, or arbitrary as in a life bar, and is used to determine how much damage (usually in terms of physical injury) a virtual character can withstand when said virtual character is attacked, or sustains a fall. The total damage dealt (which is also represented by a point value) is subtracted from the virtual character's current HP. Once the virtual character's HP reaches 0 (zero), the virtual character is usually unable to continue to fight or carry forward the virtual world's mission.

A typical life bar is a horizontal rectangle which may begin full of color. As the virtual character is attacked and sustains damage or mistakes are made, health is reduced and the colored area gradually reduces or changes color, typically from green to red. At the start of a typical game, the virtual character may have 100% health. At some point the life bar changes color completely, or loses color; at this point the virtual character is usually considered dead.

To assess damage, the system checks whether the inflicted damage to the health of the villain virtual character is greater than a threshold 204. For example, the threshold may be 8% and if repeated moves by a player are causing a 10% damage to the health of a villain virtual character then it can be safely assumed that if the player continues to repeat these moves then in 10 such moves the health of the said virtual character will reach zero and the player would have effectively defeated the villain.

If No 204a (i.e. the inflicted damage to the health of the villain virtual character is less than the defined threshold) then gameplay continues 207 and the system periodically monitors the player activity and the inflicted damage.

If Yes 204b (i.e. the inflicted damage to the health of the villain virtual character is greater than the defined threshold) then the system combines stats from different strings associated with the villain virtual character 205. The villain virtual character is evolved to incorporate the new strings 206 and gameplay continues 207 and the system periodically monitors the player activity and the inflicted damage on the villain virtual character.

The system learns when a player uses repeated moves and the moves inflict more than a given range/percentage damage to the virtual character's health points. When such a situation arises the system is able to take more than one strings associated with the villain virtual character that the player is combating with, and combine the stats from these strings to create a new string, or replace one entire string with another, to change the behavior of the villain virtual character. Thus after this change of stats by either replacing a string with another or combining stats from several strings, the moves that the player was using to inflict damage on the villain virtual character will no longer be effective and the player will have to discover another move or combination of moves to be able to defeat the villain virtual character.

Thus we note that the villain virtual character can be evolved by either changing the default script with another one that may be part of the string set for that virtual player, or by creating a new string by combining the stats of two or more strings that may be present in the string set for said virtual character. In alternate embodiments the strings may also be downloaded from a server, purchased, sold, exchanged, gifted, won, lost, etc. The invention is not limited to these examples, but the intent is to cover all such possibilities that are obvious to persons skilled in the art.

The occurrence and outcome of special bonus features, the amounts wagered on any bets, the outcomes for any intermediate game stages, the results of any player decisions made during the game, bonus plays and their outcomes, the final game outcomes etc. may also change as a result of combining the stats from different strings.

In one embodiment of the invention, a method of combining the stats of different strings associated with a virtual character may use a certain data structure to define the statistics of the virtual characters in each of the virtual worlds. One such method to save the statistics is to use an XML structure.

In one embodiment of the invention, the presence or absence of a Skill, Ability, Trait, Advantage, Disadvantage or Power is represented by a “1” or a “0” respectively. One exemplary data structure that may be used to define a virtual character's statistics is shown in FIG. 3.

The data fields may be arranged in a given order, so that the statistics from one string associated with a virtual character in a virtual world correspond to the same statistics in another string for the same virtual character in the same virtual world. In another embodiment there may be a mapping mechanism that may translate the statistics of one string associated with a virtual character to that of another string associated with the same virtual character. The data structure may be a file e.g. an XML file, or a table, or a database, or a string.

The data structure fields may be ordered to allow different strings associated with a virtual character to correspond uniformly to one another. For example, “Strength” may be the first field in this ordering, “Wisdom” may be the second field and so on. Therefore when one or more strings associated with a virtual character are combined, statistics for the relevant data fields are composed by some function, for example in one case Strength is added to Strength, while Wisdom from one string is subtracted from the value of Wisdom in another string.

In another embodiment of the invention, there may be mapping that allows the data structure fields to be mapped indirectly from one to the other so that the relevant data fields correspond with each other. This is especially relevant for derived statistics. For example, if the “Dodge Skill” in one string is composed of the “Dexterity” primary statistic and a “Dodge Training” secondary statistic, and the “Reflex Save” derived statistic in another string is composed of “Dexterity” and “Perception” primary statistics, then the “Dodge Skill” and “Reflex Save” can be composed when combining the stats from these strings.

In another embodiment, where there may be a non-uniform number of data fields (if, for example, one set of statistics has 5 data fields and the other set of statistics has 8 data fields) the mapping allows for the relevant data fields to correspond. Thus the combined string may take all or some of the stats when creating a new string to change the behavior of the virtual character.

For each of the statistics that are present in a virtual character, there may be a corresponding value that defines the extent of that particular statistic. For some statistics the possible range of values may include positive numbers, zero and negative numbers. Thus when the value is a positive number there may be a beneficial effect (positive effect), while a zero implies no effect and a negative number implies a negative effect. One such exemplary data structure showing a string of statistics associated with a given virtual character is shown in FIG. 5. The top row shows the presence or absence of a particular statistic while the second row shows a value that defines the quality of that particular statistic if it is present.

Another exemplary data structure showing the statistics of a second string associated with the same virtual character is shown in FIG. 5. The top row shows the presence or absence of a particular statistic while the second row shows a value that defines the quality of that particular statistic if it is present.

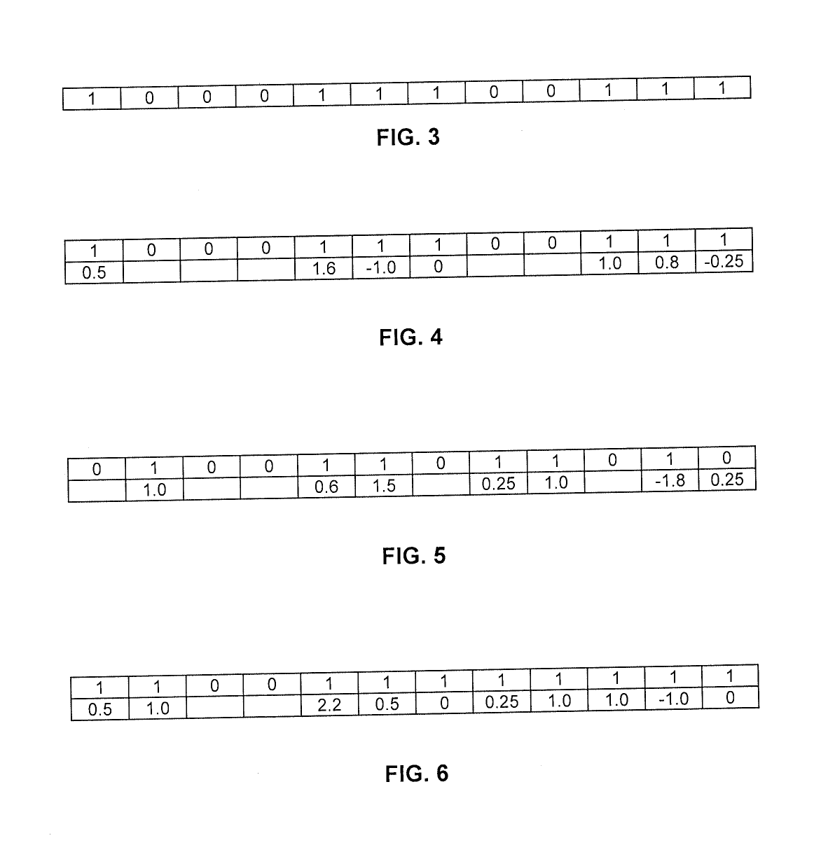

In one embodiment when a first string associated with a given virtual character in a virtual world is combined with a second string also associated with the same virtual character, the resultant statistics may be an addition (super-set) of the two previous individual statistics of the first and second strings associated with the said virtual character. FIG. 6 shows the resultant statistics when statistics of a first string associated with a virtual character in a virtual world (FIG. 4) are combined with the stats of a second string also associated with the same virtual character (FIG. 5). This in FIG. 6, we see that in the top row statistics are a super-set of the individual statistics of the FIG. 4 and FIG. 5.

Similarly the values of the individual statistics that were present in both strings associated with the virtual character may get added (as in this example). Thus values of certain statistics would get reinforced (if both individual values of a certain statistic were either positive or negative) while values of certain other statistics may get negatively impacted (if one value was positive and the other value was negative) due to the combining of the strings associated with said virtual character.

There may be many different methods of combining the statistics for example in one embodiment while some statistics are added, others are deleted or subtracted as a result of combining two or more strings associated with the same virtual character. The resultant stats are saved as a new string which later may be used for combining with previously existing strings. Thus over time, more and more strings are available for changing the behavior of a virtual character to create variations in the encounters with players.

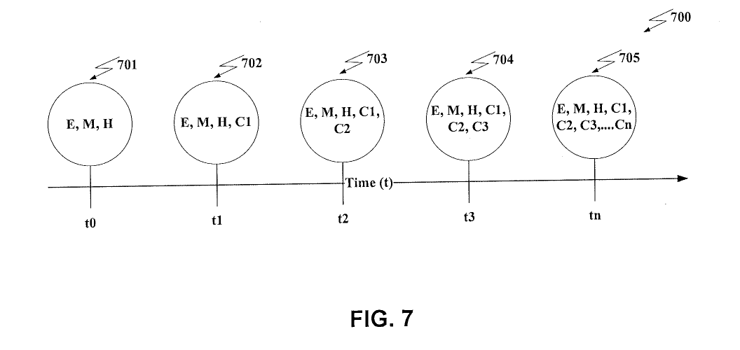

In one embodiment there may be more than one default scripts associated with a certain virtual character and are already embedded in a virtual world (game), but are dormant and may get invoked once a player or players discover how to defeat the villain easily. In one embodiment there may be generic scripts associated with virtual characters for example Easy, Medium, Hard etc. As an example stats from the Easy string may be combined with the stats of the Hard string once the players start to defeat the villain easily using repetitive moves. This results in a new string that may be saved to the game and at a later point when stats from more than one string need to be combined, this string may also be used in addition to the default strings that were already embedded in the virtual world. FIG. 7 illustrates this in more detail.

FIG. 7 shows the changes to a string set for a virtual character over a period of time 700. At the start of the game, there may be some default strings associated with a virtual character. This is depicted by time t0, where the string set 701 may consist of three strings Easy (E), Medium (M) and Hard (H).

As time passes and player(s) have interacted with the virtual character and all strings in string set 701 have been used to alter the behavior of the virtual character, combine stats from more than one strings to form a new string C1 (any possible combination of E, M and H strings). This forms the new string set 702 at Time t1 which now consists of string E, M, H and C1.

Similarly, at Time t2, the string set 703 now contains string E, M, H, C1 and C2. As more time passes and player have already engaged in the gameplay involving all the strings in string set 703, a new string C3 is added, thus at Time t3, the string set 704 now contains string E, M, H, C1, C2 and C3. This continues and at Time tn, there are many more strings in the string set 705 including E, M, H, C1, C2, C3 up to Cn.

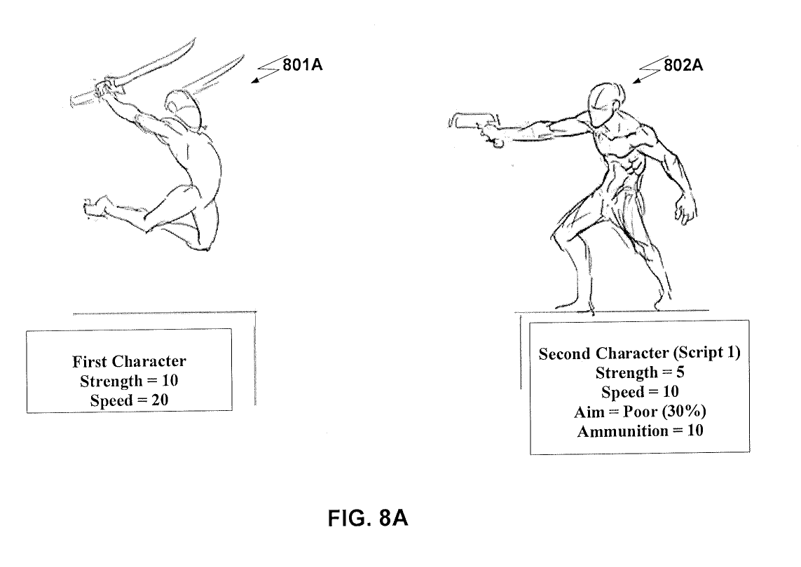

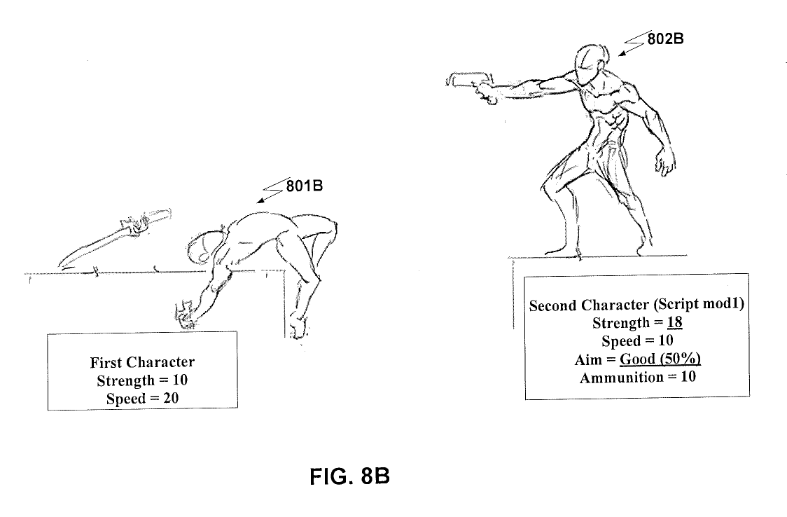

Turning to FIGS. 8A and 8B, an example is shown of an interaction where the change in string or script has an effect on the outcome. A default script (Script “1”) is invoked in the interaction between First Character 801A and Second Character 802A in FIG. 8A. Under these circumstances, the jump attack planned by First Character 801A would ordinarily result in First Character 801A defeating Second Character 802A. First Character 801A has greater strength and speed than Second Character 802A.

However, the tables are turned in FIG. 8B. Due to script change (arising from prior recognition of a pattern of repetitive and damaging moves by the first character against the second character), the script for Second Character 802B has been changed. Here, the Second Character's 802B strength and aim stat sub-components have been reshuffled with those of another script (not shown) and are increased. So now, as shown, Second Character 802B is able to defeat First Character 801B by virtue of Second Character's 802B improved aim under Script “Mod 1”.

The application is not limited to the cited examples, but the intent is to cover all such areas that may be used in a virtual world to impact the evolution of virtual characters in a virtual world.

In one embodiment of the invention the combined statistics are derived by taking an average of the individual statistics of the different strings associated with the said virtual character. The number of strings used to come up with a new combined sting may vary from one application to another. Thus at least two stings may be required to come up with a new combination. There can be many variations when using multiple strings e.g. using 3 stings, using 4 stings, using 5 stings with average of all stat elements, using 4 strings with weighted averages etc.

In another embodiment of the invention the combined statistics are derived by taking a weighted average of the individual statistics of two or more strings associated with said virtual character, with preference (weight) given to any one of the stats where the preference can be either user defined, based on the player's gaming style or system driven.

A player's gaming style can be defined by player preferences, which may have been captured by either tracking the player's gaming style or by asking the player a series of questions, and then the answers from these questions determining the gaming style which in turn impacts the evolution of the virtual characters. That is how stings are combined, or which elements in the stings are combined may vary with the gaming style of the player.

A script defines the default behavior of a virtual character. Just as with statistics, different scripts can refer to different behaviors. Using the method and system of the invention, a default script of a virtual character may define its default behavior and in order to implement an altered behavior associated with a change in location a certain other script may be used instead of the default script of a virtual character.

The system of the invention may import scripts associated with virtual characters, so that the resulting combination is more varied and thus more sophisticated.

In another embodiment the scripts associated with different virtual characters may be downloaded (either automatically or by player request) from a central server that acts as a repository for additional scripts. In another embodiment the user may have to pay when acquiring these additional scripts e.g. from a remote server.

In another embodiment the combined statistics are derived by taking an average of the individual statistics of the different strings associated with a virtual character.

In yet another embodiment the combined statistics are derived by taking a weighted average of the individual statistics of the different strings associated with the virtual characters, with preference (weight) given to any one of the stats and where the preference can be either user defined or system driven.

It should be understood that although the terms “script” and “string” have been used interchangeably to imply the mechanism for altering the behavior of the virtual character, the intent is to cover all such mechanism that can provide this functionality.

One embodiment of the invention may preferably also provide a framework or an API (Application Programming Interface) for virtual world creation that allows a developer to incorporate the functionality of evolving virtual characters as more players interact with them. Using such a framework or API allows for a more exciting virtual world generation, and eventually allows for more complex and extensive ability to keep a player engaged over a longer duration of gameplay.

It should be understood that although the term game has been used as an example in this application but in essence the term may also imply any other piece of software code where the embodiments of the invention are incorporated. The software application can be implemented in a standalone configuration or in combination with other software programs and is not limited to any particular operating system or programming paradigm described here. For the sake of simplicity, we singled out game applications for our examples. Similarly we described users of these applications as players. There is no intent to limit the disclosure to game applications or player applications. The terms players and users are considered synonymous and imply the same meaning. Likewise, virtual worlds, games and applications imply the same meaning. Thus, this application intends to cover all applications and user interactions described above and ones obvious to persons skilled in the art.

Although virtual world have been exemplified above with reference to gaming, it should be noted that virtual worlds are also associated with many industries and applications. For example, virtual worlds can be used in movies, cartoons, computer simulations, and video simulations, among others. All of these industries and applications would benefit invention.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

What is claimed is:

1. A computer-implemented method of providing virtual gameplay on a computing device in communication with a storage means, the method comprising the steps of:
providing access to a video game in which players are able to interact via characters and each character behaves according to a series of scripts in a script set;
monitoring a first player character as it interacts with a second character in the video game, wherein the second character responds according to a script in its script set;
upon the first player character exhibiting repetitive behaviour in the interaction that causes damage to the second character that exceeds a preset damage threshold, changing the second character's script; and
storing the changed script on the storage means for future use.

2. The method of claim 1, wherein changing the script includes replacing the script with another script from the script set.

3. The method of claim 2, wherein the replacement script is for a higher level than would otherwise be default.

4. The method of claim 1, wherein each script has at least two sub-components and wherein changing the script includes combining or replacing at least one of the sub-components with sub-components from another script in the script set.

5. The method of claim 4, wherein each sub-component includes at least one statistic.

6. The method of claim 5, wherein the statistic is a primary statistic or a derived statistic.

7. The method of claim 6, wherein changing the script includes changing the formula or algorithm by which a derived statistic in the sub-component is derived.

8. The method of claim 1, wherein changing the script includes combining or replacing the script with a script that has been downloaded, transferred, purchased, gifted, won, or lost, or restored or linked from another game.

9. The method of claim 1, further comprising allowing the first player character to continue the interaction with the second character with the changed script invoked, and wherein the second character behaves according to the changed script.

10. The method of claim 9, wherein the second character is detectably strengthened by invocation of the changed script.

11. The method of claim 9, wherein the second character is detectably faster by invocation of the changed script.

12. The method of claim 9, wherein the second character has at least one non-default move, attack or defence by invocation of the changed script.

13. The method of claim 9, wherein the second character has at least one non-default tool or weapon by invocation of the changed script.

14. The method of claim 9, wherein the second character has detectably increased health or life by invocation of the changed script.

15. The method of claim 1, wherein the storage means is provided by one or a combination of: a local fixed memory, a local removable memory, a remote fixed memory, a remote removable memory, and a virtual memory.
